(19) United States
(12) Patent Application Publication
(10) Pub. No.: US 2026/0277049 A1
(43) Pub. Date: Sep. 17, 2026

(54) DISPLAY PANEL

(71) Applicant: HannStar Display Corporation, Taipei City (TW)

(72) Inventors: Ting Wei Liu, Taipei City (TW); Chia-Yu Liu, Taipei City (TW)

(73) Assignee: HannStar Display Corporation, Taipei City (TW)

(21) Appl. No.: 19/203,222

(22) Filed: May 9, 2025

(30) Foreign Application Priority Data
Mar. 14, 2025 (TW) 114109481

(51) Int. Cl. G02F 1/1335; G02F 1/1337

(52) U.S. Cl. CPC G02F 1/133524; G02F 1/133531; G02F 1/133746; G02F 2203/01; G02F 2203/02

(57) ABSTRACT

A display panel of the disclosure includes a first polarizer, a second polarizer, a liquid crystal layer, a first quarter-wave plate and a second quarter-wave plate. The first polarizer has a first absorption axis. The second polarizer overlaps the first polarizer and has a second absorption axis. The liquid crystal layer is disposed between the first polarizer and the second polarizer and has an alignment axial direction. The first quarter-wave plate is disposed between the first polarizer and the liquid crystal layer and has a first optical axis. The second quarter-wave plate is disposed between the second polarizer and the liquid crystal layer and has a second optical axis. An included angle between the alignment axial direction of the liquid crystal layer and each of the first optical axis and the second optical axis is greater than or equal to 0 degrees and less than or equal to 10 degrees.

### CROSS-REFERENCE TO RELATED APPLICATION

This application claims the priority benefit of Taiwan application serial no. 114109481, filed on Mar. 14, 2025. The entirety of the above-mentioned patent application is hereby incorporated by reference herein and made a part of this specification.

### BACKGROUND

### Technical Field

The disclosure relates to a display technology, and in particular, to a display panel.

### Description of Related Art

Transflective liquid crystal display (LCD) panels have been increasingly favored in the market due to their ability to meet requirements under different lighting environments (such as low ambient light indoors and strong ambient light outdoors) as well as their energy-saving characteristics. Typically, a reflective layer of a transflective LCD panel is made of silver metal to achieve high reflectivity. However, when the display panel operates in a dark state, the high reflectivity of the silver layer may lead to multiple scattering of light between the reflective layer and the liquid crystal layer, eventually causing light leakage through the polarizer. On the other hand, since the phase retardation induced by the liquid crystal layer differs between the transmissive area and the reflective area, it is difficult to achieve an optimal dark-state performance for both reflective and transmissive modes even with a compensation film.

### SUMMARY

The disclosure provides a display panel with a better contrast ratio in the display operations of a reflective mode and a transmissive mode.

A display panel of the disclosure includes a first polarizer, a second polarizer, a liquid crystal layer, a first quarter-wave plate and a second quarter-wave plate. The first polarizer has a first absorption axis. The second polarizer overlaps the first polarizer and has a second absorption axis. The liquid crystal layer is disposed between the first polarizer and the second polarizer and has an alignment axial direction. The first quarter-wave plate is disposed between the first polarizer and the liquid crystal layer and has a first optical axis. The second quarter-wave plate is disposed between the second polarizer and the liquid crystal layer and has a second optical axis. An included angle between the alignment axial direction of the liquid crystal layer and each of the first optical axis and the second optical axis is greater than or equal to 0 degrees and less than or equal to 10 degrees.

In an embodiment of the disclosure, the first optical axis and the second optical axis of the display panel are both parallel to the alignment axial direction of the liquid crystal layer.

In an embodiment of the disclosure, the display panel further includes a first half-wave plate and a second half-wave plate. The first half-wave plate is disposed between the first polarizer and the first quarter-wave plate and has a third optical axis. The second half-wave plate is disposed between the second polarizer and the second quarter-wave plate and has a fourth optical axis. A first included angle is provided between the third optical axis and the first absorption axis. A second included angle is provided between the fourth optical axis and the second absorption axis. A sum of the first included angle and the second included angle is 90 degrees.

In an embodiment of the disclosure, one of the first included angle and the second included angle of the display panel is 15 degrees. The other of the first included angle and the second included angle is 75 degrees.

In an embodiment of the disclosure, the display panel further includes a reflective layer and a pixel electrode. The reflective layer is disposed between the liquid crystal layer and the second quarter-wave plate. The reflective layer defines a reflective area of the display panel. The pixel electrode is disposed overlapping the reflective layer. A portion of the pixel electrode not overlapping the reflective layer defines a transmissive area of the display panel. A maximum phase retardation of the liquid crystal layer in the transmissive area is greater than or equal to 270 nm and less than or equal to 340 nm.

In an embodiment of the disclosure, the display panel further includes a first half-wave plate and a second half-wave plate. The first half-wave plate is disposed between the first polarizer and the first quarter-wave plate and has a third optical axis. The second half-wave plate is disposed between the second polarizer and the second quarter-wave plate and has a fourth optical axis. A first included angle is provided between the third optical axis and the first absorption axis. A second included angle is provided between the fourth optical axis and the second absorption axis. The first included angle is greater than or equal to 0 degrees and less than or equal to 30 degrees. The second included angle is greater than or equal to 60 degrees and less than or equal to 90 degrees.

In an embodiment of the disclosure, the display panel further includes a first half-wave plate and a second half-wave plate. The first half-wave plate is disposed between the first polarizer and the first quarter-wave plate and has a third optical axis. The second half-wave plate is disposed between the second polarizer and the second quarter-wave plate and has a fourth optical axis. A first included angle is provided between the third optical axis and the first absorption axis. A second included angle is provided between the fourth optical axis and the second absorption axis. The first included angle is greater than or equal to 60 degrees and less than or equal to 90 degrees. The second included angle is greater than or equal to 0 degrees and less than or equal to 30 degrees.

In an embodiment of the disclosure, the display panel further includes a first alignment layer and a second alignment layer. The first alignment layer is disposed between the liquid crystal layer and the first quarter-wave plate and has a first alignment direction. The second alignment layer is disposed between the liquid crystal layer and the second quarter-wave plate and has a second alignment direction. The first alignment direction is anti-parallel to the second alignment direction. The first alignment direction and the second alignment direction define the alignment axial direction of the liquid crystal layer.

A display panel of the disclosure includes a first polarizer, a second polarizer, a first alignment layer, a second alignment layer, a liquid crystal layer, a reflective layer and a pixel electrode. The first polarizer has a first absorption axis. The second polarizer overlaps the first polarizer and has a second absorption axis. The first alignment layer is disposed between the first polarizer and the second polarizer and has a first alignment direction. The second alignment layer is disposed between the first polarizer and the second polarizer and has a second alignment direction. The first alignment direction is anti-parallel to the second alignment direction. The liquid crystal layer is disposed between the first alignment layer and the second alignment layer. An included angle between the first alignment direction or the second alignment direction and each of the first absorption axis and the second absorption axis is 45 degrees. The reflective layer is disposed between the second alignment layer and the second polarizer. The pixel electrode is disposed between the second alignment layer and the second polarizer and overlaps the reflective layer. The reflective layer defines a reflective area of the display panel. A portion of the pixel electrode not overlapping the reflective layer defines a transmissive area of the display panel. A maximum phase retardation of the liquid crystal layer in the transmissive area is greater than or equal to 250 nm and less than or equal to 300 nm. A maximum phase retardation of the liquid crystal layer in the reflective area is greater than or equal to 115 nm and less than or equal to 160 nm.

In an embodiment of the disclosure, the first absorption axis of the display panel is parallel to the second absorption axis.

Based on the above, in a display panel according to an embodiment of the disclosure, a quarter-wave plate is provided between the liquid crystal layer and each of the first polarizer and the second polarizer. By limiting the included angle between the alignment axial direction of the liquid crystal layer and each quarter-wave plate to within 10 degrees, the operating voltage required for the liquid crystal layer can be significantly reduced, and the contrast ratio of the display panel can be greatly improved. In a display panel according to another embodiment of the disclosure, the included angle between the alignment axial direction of the liquid crystal layer and each of the absorption axes of two polarizers is designed to be 45 degrees and designing the liquid crystal layer to have different maximum phase retardations in the reflective area and the transmissive area, the contrast ratio of the display panel can be significantly improved, while also achieving consistent optical performance of the display panel in the transmissive area and the reflective area.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a display panel according to a first embodiment of the disclosure.

FIG. 2 is schematic diagram illustrating the relationship between the absorption ax of the polarizer, the optical axis of the half-wave plate, the optical axis of the quarter-wave plate and the alignment axial direction of the liquid crystal layer of FIG. 1.

FIG. 3 is schematic diagram illustrating the relationship between the absorption ax of the polarizer, the optical axis of the half-wave plate, the optical axis of the quarter-wave plate and the alignment axial direction of the liquid crystal layer in another modified embodiment of the display panel of FIG. 1.

FIG. 4 is schematic diagram illustrating the relationship between the absorption ax of the polarizer, the optical axis of the half-wave plate, the optical axis of the quarter-wave plate and the alignment axial direction of the liquid crystal layer in still another modified embodiment of the display panel of FIG. 1.

FIG. 5 is a schematic cross-sectional view of a display panel according to a second embodiment of the disclosure.

FIG. 6 is a schematic diagram illustrating the relationship between the absorption axis of the polarizer and the alignment axial direction of the liquid crystal layer of FIG. 5.

### DESCRIPTION OF THE EMBODIMENTS

The aforementioned and other technical aspects, features, and effects of the present invention will become apparent in the following detailed description of a preferred embodiment, which is provided with reference to the accompanying drawings. Directional terms such as up, down, left, right, front, or back mentioned in the embodiment are used only for referencing the orientations shown in the drawings. Therefore, these directional terms are intended for illustrative purposes only and are not meant to limit the scope of the present invention.

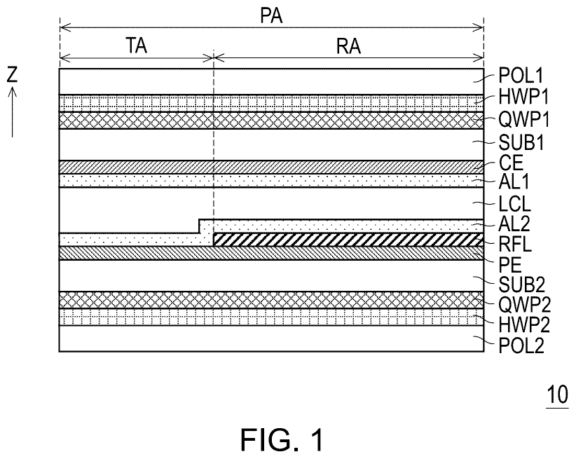

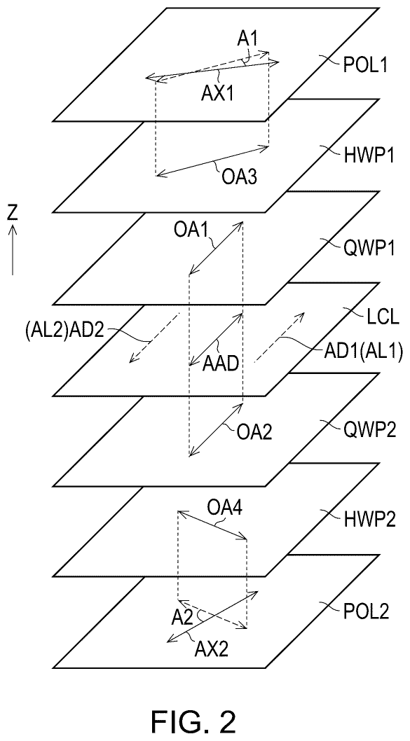

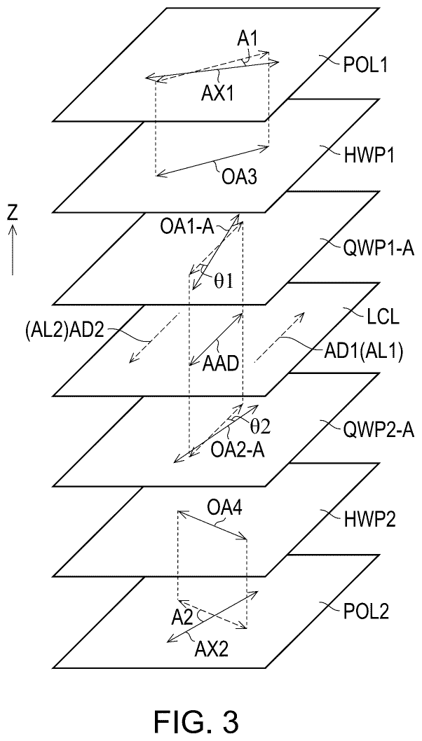

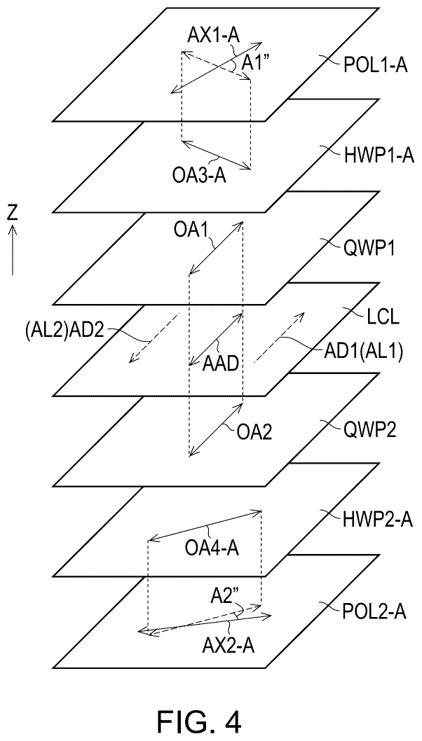

FIG. 1 is a schematic cross-sectional view of a display panel according to a first embodiment of the disclosure. FIG. 2 is schematic diagram illustrating the relationship between the absorption axis of the polarizer, the optical axis of the half-wave plate, the optical axis of the quarter-wave plate and the alignment axial direction of the liquid crystal layer of FIG. 1. FIG. 3 is schematic diagram illustrating the relationship between the absorption axis of the polarizer, the optical axis of the half-wave plate, the optical axis of the quarter-wave plate and the alignment axial direction of the liquid crystal layer in another modified embodiment of the display panel of FIG. 1. FIG. 4 is schematic diagram illustrating the relationship between the absorption axis of the polarizer, the optical axis of the half-wave plate, the optical axis of the quarter-wave plate and the alignment axial direction of the liquid crystal layer in still another modified embodiment of the display panel of FIG. 1.

Referring to FIG. 1 and FIG. 2, a display panel 10 includes a first substrate SUB1, a second substrate SUB2, a liquid crystal layer LCL, a first alignment layer AL1, a second alignment layer AL2, a first polarizer POL1, and a second polarizer POL2. The first substrate SUB1 and the second substrate SUB2 are overlapped with each other along a direction Z. The liquid crystal layer LCL is disposed between the first substrate SUB1 and the second substrate SUB2. The first polarizer POL1 is disposed on one side of the first substrate SUB1 facing away from the liquid crystal layer LCL and has a first absorption axis AX1. The second polarizer POL2 is disposed on one side of the second substrate SUB2 facing away from the liquid crystal layer LCL and has a second absorption axis AX2. The first polarizer POL1 and the second polarizer POL2 are disposed overlapping each other along the direction Z. The liquid crystal layer LCL is located between the first polarizer POL1 and the second polarizer POL2.

The first alignment layer AL1 is disposed between the liquid crystal layer LCL and the first substrate SUB1 and has a first alignment direction AD1. The second alignment layer AL2 is disposed between the liquid crystal layer LCL and the second substrate SUB2 and has a second alignment direction AD2. The first alignment direction AD1 and the second alignment direction AD2 define an alignment axial direction AAD of the liquid crystal layer LCL. In the embodiment, the first alignment direction AD1 of the first alignment layer AL1 may be anti-parallel to the second alignment direction AD2 of the second alignment layer AL2. That is, the liquid crystal layer LCL of the embodiment is driven in an electrically controlled birefringence (ECB) mode.

FIG. 1 illustrates a stacked structure of a display panel 10 in a pixel area PA of the embodiment. It is understood that, when viewed from the front of the display panel 10 (e.g., an opposite direction of direction Z), the display panel 10 may be provided with a plurality of pixel areas PA arranged in an array on a display surface, and these pixel areas PA may be arranged along two mutually perpendicular directions perpendicular to the front viewing direction, but the disclosure is not limited thereto.

In order to drive the liquid crystal layer LCL, a pixel electrode PE and a common electrode CE may be further disposed in each pixel area PA. For example, in the embodiment, the common electrode CE and the pixel electrode PE may be disposed on the first substrate SUB1 and the second substrate SUB2 respectively. The pixel electrode PE and the common electrode CE are, for example, light-transmitting electrodes, and the material of the light-transmitting electrodes includes, for example, metal oxides, such as indium tin oxide, indium zinc oxide, aluminum tin oxide, aluminum zinc oxide, or other suitable oxides, or a stacked layer of at least two of the above. In the embodiment, a plurality of active devices (not shown), a plurality of data lines (not shown) and a plurality of scan lines (not shown) may be further disposed on the second substrate SUB2. For example, these active devices may be respectively disposed in the plurality of pixel areas PA, and electrically connected to a corresponding pixel electrode PE, a corresponding scan line, and a corresponding data line, but the disclosure is not limited thereto.

Furthermore, each pixel area PA of the display panel 10 is further provided with a reflective layer RFL. In the embodiment, the reflective layer RFL is disposed on the second substrate SUB2 and directly covers a portion of the pixel electrode PE. The material of the reflective layer RFL includes, for example, silver, aluminum, or other materials with high reflectivity. The reflective layer RFL defines a reflective area RA of the display panel 10, and a portion of the pixel electrode PE that does not overlap (or is not covered by) the reflective layer RFL defines a transmissive area TA of the display panel 10. Preferably, a maximum phase retardation of the liquid crystal layer LCL in the transmissive area TA may be greater than or equal to 270 nm and less than or equal to 340 nm.

Since light passing through the reflective area RA of the display panel 10 traverses the liquid crystal layer LCL twice while light passing through the transmissive area TA of the display panel 10 traverses the liquid crystal layer LCL once, there is a significant difference in the optical path length (or phase retardation) induced by the liquid crystal layer LCL between the reflective area RA and the transmissive area TA. As a result, it is difficult to achieve consistent optical performance between the reflective area RA and the transmissive area TA, particularly in the dark state, where light leakage is prone to occur.

To solve this problem, the display panel 10 further includes a first quarter-wave plate QWP1 and a second quarter-wave plate QWP2. The first quarter-wave plate QWP1 is disposed between the first polarizer POL1 and the liquid crystal layer LCL and has a first optical axis OA1. The second quarter-wave plate QWP2 is disposed between the second polarizer POL2 and the liquid crystal layer LCL and has a second optical axis OA2. The reflective layer RFL is located between the second quarter-wave plate QWP2 and the liquid crystal layer LCL.

In the embodiment, the display panel 10 may further include a first half-wave plate HWP1 and a second half-wave plate HWP2. The first half-wave plate HWP1 is disposed between the first polarizer POL1 and the first quarter-wave plate QWP1 and has a third optical axis OA3. The second half-wave plate HWP2 is disposed between the second polarizer POL2 and the second quarter-wave plate QWP2 and has a fourth optical axis OA4.

It is particularly noted that, in the embodiment, the first optical axis OA1 of the first quarter-wave plate QWP1 and the second optical axis OA2 of the second quarter-wave plate QWP2 may be parallel to the alignment axial direction AAD of the liquid crystal layer LCL, but the disclosure is not limited thereto. In the modified embodiment of FIG. 3, an included angle θ1 between the first optical axis OA1-A of the first quarter-wave plate QWP1-A and the alignment axial direction AAD of the liquid crystal layer LCL and an included angle θ2 between the second optical axis OA2-A of the second quarter-wave plate QWP2-A and the alignment axial direction AAD of the liquid crystal layer LCL can be greater than or equal to 0 degrees and less than or equal to 10 degrees.

In the embodiment, since the first optical axis OA1 of the first quarter-wave plate QWP1 and the second optical axis OA2 of the second quarter-wave plate QWP2 are both parallel to the alignment axial direction AAD of the liquid crystal layer LCL, not only the operating voltage required for the liquid crystal layer LCL can be significantly reduced, but also the contrast ratio of the display panel 10 can be greatly improved.

In particular, the combination of a quarter-wave plate and a half-wave plate disposed between the polarizer and the liquid crystal layer LCL can effectively suppress the dispersion phenomenon of light after passing through the display panel 10, which helps to reduce light leakage in the dark state of the display. That is, the combination of the first quarter-wave plate QWP1 and the first half-wave plate HWP1 and the combination of the second quarter-wave plate QWP2 and the second half-wave plate HWP2 exhibit the characteristic of broadband compensation.

On the other hand, a first included angle A1 is provided between the third optical axis OA3 of the first half-wave plate HWP1 and the first absorption axis AX1 of the first polarizer POL1. A second included angle A2 is provided between the fourth optical axis OA4 of the second half-wave plate HWP2 and the second absorption axis AX2 of the second polarizer POL2. In the embodiment, the first included angle A1 may be greater than or equal to 0 degrees and less than or equal to 30 degrees, and the second included angle A2 may be greater than or equal to 60 degrees and less than or equal to 90 degrees. Accordingly, the contrast ratio of the display panel 10 can be further improved. It is particularly noted that when a sum of the first included angle A1 and the second included angle A2 is 90 degrees, the display panel 10 can have a higher contrast ratio. For example, in the embodiment, the first included angle A1 is 15 degrees, and the second included angle A2 is 75 degrees.

However, the disclosure is not limited thereto. In the modified embodiment of FIG. 4, the first included angle A1″ between the third optical axis OA3-A of the first half-wave plate HWP1-A and the first absorption axis AX1-A of the first polarizer POL1-A may be greater than or equal to 60 degrees and less than or equal to 90 degrees, and the second included angle A2″ between the fourth optical axis OA4-A of the second half-wave plate HWP2-A and the second absorption axis AX2-A of the second polarizer POL2-A may be greater than or equal to 0 degrees and less than or equal to 30 degrees. Under this condition, the contrast ratio of the display panel can also be further improved. Preferably, the sum of the first included angle A1″ and the second included angle A2″ is 90 degrees. For example, the first included angle A1″ is 75 degrees, and the second included angle A2″ is 15 degrees.

Other embodiments will be listed below to explain the present disclosure in detail, wherein the same components will be marked with the same symbols, and the description of the same technical content will be omitted. For the omitted parts, please refer to the aforementioned embodiments and will not be repeated below.

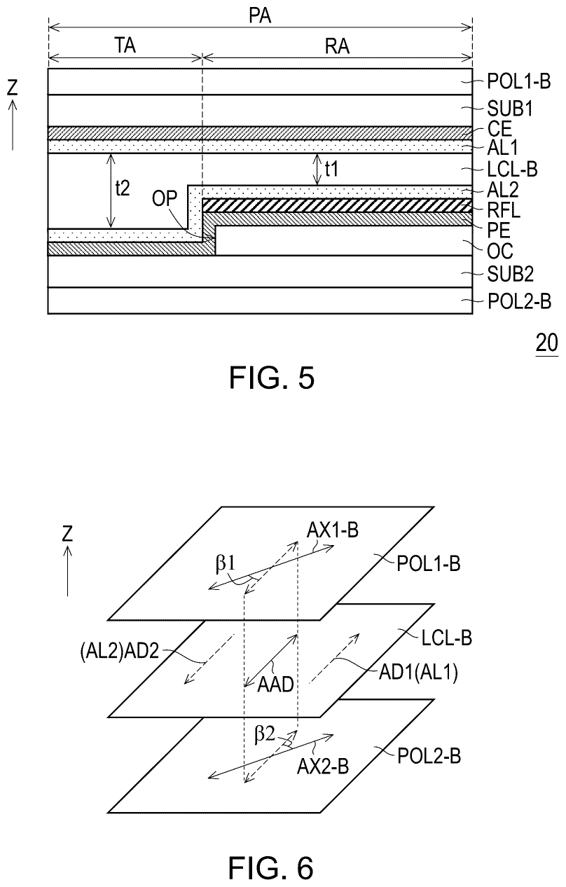

FIG. 5 is a schematic cross-sectional view of a display panel according to a second embodiment of the disclosure. FIG. 6 is a schematic diagram illustrating the relationship between the absorption axis of the polarizer and the alignment axial direction of the liquid crystal layer of FIG. 5. Referring to FIG. 5 and FIG. 6, the main difference between a display panel 20 of the embodiment and the display panel 10 of FIG. 1 lies in that the display panel 20 of the embodiment is not provided with the first quarter-wave plate QWP1, the second quarter-wave plate QWP2, the first half-wave plate HWP1 and the second half-wave plate HWP2 of FIG. 1. Therefore, the display panel 20 of the embodiment may offer a better cost advantage.

In the embodiment, an included angle β1 between the first absorption axis AX1-B of the first polarizer POL1-B and the alignment axial direction AAD (or the first alignment direction AD1/the second alignment direction AD2) of the liquid crystal layer LCL-B is 45 degrees, and an included angle β2 between the second absorption axis AX2-B of the second polarizer POL2-B and the alignment axial direction AAD (or the first alignment direction AD1/the second alignment direction AD2) of the liquid crystal layer LCL-B is 45 degrees, wherein the first absorption axis AX1-B is parallel to the second absorption axis AX2-B. Accordingly, the display panel 20 may have a better contrast ratio.

On the other hand, in the embodiment, a thickness t2 of the liquid crystal layer LCL-B in the transmissive area TA may be greater than a thickness t1 of the liquid crystal layer LCL-B in the reflective area RA. That is, a maximum phase retardation of the liquid crystal layer LCL-B in the transmissive area TA is greater than a maximum phase retardation of the liquid crystal layer LCL-B in the reflective area RA. Preferably, the maximum phase retardation of the liquid crystal layer LCL-B in the transmissive area TA is greater than or equal to 250 nm and less than or equal to 300 nm, and the maximum phase retardation of the liquid crystal layer LCL-B in the reflective area RA is greater than or equal to 115 nm and less than or equal to 160 nm. Accordingly, the optical path difference of light between the transmissive area TA and the reflective area RA can be reduced, thereby improving the consistency of the optical performance (e.g., brightness and chroma) of the display panel 20 in the reflective area RA and the transmissive area TA.

For example, in the embodiment, the second substrate SUB2 may further be provided with an overcoat layer OC, and the overcoat layer OC has an opening OP overlapping the transmissive area TA. The design of the opening OP allows the liquid crystal layer LCL-B to have different thicknesses in the transmissive area TA and the reflective area RA. However, the disclosure is not limited thereto. In other embodiments, a overcoat layer or an insulation layer having an opening may be disposed on the first substrate SUB1.

To sum up, in a display panel according to an embodiment of the disclosure, a quarter-wave plate is provided between the liquid crystal layer and each of the first polarizer and the second polarizer. By limiting the included angle between the alignment axial direction of the liquid crystal layer and each quarter-wave plate to within 10 degrees, the operating voltage required for the liquid crystal layer can be significantly reduced, and the contrast ratio of the display panel can be greatly improved. In a display panel according to another embodiment of the disclosure, the included angle between the alignment axial direction of the liquid crystal layer and each of the absorption axes of two polarizers is designed to be 45 degrees and designing the liquid crystal layer to have different maximum phase retardations in the reflective area and the transmissive area, the contrast ratio of the display panel can be significantly improved, while also achieving consistent optical performance of the display panel in the transmissive area and the reflective area.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display panel, comprising:
a first polarizer, having a first absorption axis;
a second polarizer, overlapping the first polarizer and having a second absorption axis;
a liquid crystal layer, disposed between the first polarizer and the second polarizer and having an alignment axial direction;
a first quarter-wave plate, disposed between the first polarizer and the liquid crystal layer and having a first optical axis; and
a second quarter-wave plate, disposed between the second polarizer and the liquid crystal layer and having a second optical axis, wherein an included angle between the alignment axial direction of the liquid crystal layer and each of the first optical axis and the second optical axis is greater than or equal to 0 degrees and less than or equal to 10 degrees.

2. The display panel according to claim 1, wherein the first optical axis and the second optical axis are both parallel to the alignment axial direction of the liquid crystal layer.

3. The display panel according to claim 1, further comprising:
a first half-wave plate, disposed between the first polarizer and the first quarter-wave plate and having a third optical axis; and
a second half-wave plate, disposed between the second polarizer and the second quarter-wave plate and having a fourth optical axis, wherein a first included angle is provided between the third optical axis and the first absorption axis, a second included angle is provided between the fourth optical axis and the second absorption axis, and a sum of the first included angle and the second included angle is 90 degrees.

4. The display panel according to claim 3, wherein one of the first included angle and the second included angle is 15 degrees, and the other of the first included angle and the second included angle is 75 degrees.

5. The display panel according to claim 1, further comprising:
a reflective layer, disposed between the liquid crystal layer and the second quarter-wave plate, the reflective layer defines a reflective area of the display panel; and
a pixel electrode, disposed overlapping the reflective layer, wherein a portion of the pixel electrode not overlapping the reflective layer defines a transmissive area of the display panel, and a maximum phase retardation of the liquid crystal layer in the transmissive area is greater than or equal to 270 nm and less than or equal to 340 nm.

6. The display panel according to claim 5, further comprising:
a first half-wave plate, disposed between the first polarizer and the first quarter-wave plate and having a third optical axis; and
a second half-wave plate, disposed between the second polarizer and the second quarter-wave plate and having a fourth optical axis,
wherein a first included angle is provided between the third optical axis and the first absorption axis, a second included angle is provided between the fourth optical axis and the second absorption axis, the first included angle is greater than or equal to 0 degrees and less than or equal to 30 degrees, and the second included angle is greater than or equal to 60 degrees and less than or equal to 90 degrees.

7. The display panel according to claim 5, further comprising:
a first half-wave plate, disposed between the first polarizer and the first quarter-wave plate and having a third optical axis; and
a second half-wave plate, disposed between the second polarizer and the second quarter-wave plate and having a fourth optical axis,
wherein a first included angle is provided between the third optical axis and the first absorption axis, a second included angle is provided between the fourth optical axis and the second absorption axis, the first included angle is greater than or equal to 60 degrees and less than or equal to 90 degrees, and the second included angle is greater than or equal to 0 degrees and less than or equal to 30 degrees.

8. The display panel according to claim 1, further comprising:
a first alignment layer, disposed between the liquid crystal layer and the first quarter-wave plate and having a first alignment direction; and
a second alignment layer, disposed between the liquid crystal layer and the second quarter-wave plate and having a second alignment direction, wherein the first alignment direction is anti-parallel to the second alignment direction, and the first alignment direction and the second alignment direction define the alignment axial direction of the liquid crystal layer.

9. A display panel, comprising:
a first polarizer, having a first absorption axis;
a second polarizer, overlapping the first polarizer and having a second absorption axis;
a first alignment layer, disposed between the first polarizer and the second polarizer and having a first alignment direction;
a second alignment layer, disposed between the first polarizer and the second polarizer and having a second alignment direction, wherein the first alignment direction is anti-parallel to the second alignment direction;
a liquid crystal layer, disposed between the first alignment layer and the second alignment layer, wherein an included angle between the first alignment direction or the second alignment direction and each of the first absorption axis and the second absorption axis is 45 degrees;
a reflective layer, disposed between the second alignment layer and the second polarizer; and
a pixel electrode, disposed between the second alignment layer and the second polarizer and overlapping the reflective layer, wherein the reflective layer defines a reflective area of the display panel, a portion of the pixel electrode not overlapping the reflective layer defines a transmissive area of the display panel, a maximum phase retardation of the liquid crystal layer in the transmissive area is greater than or equal to 250 nm and less than or equal to 300 nm, and a maximum phase retardation of the liquid crystal layer in the reflective area is greater than or equal to 115 nm and less than or equal to 160 nm.

10. The display panel according to claim 9, wherein the first absorption axis is parallel to the second absorption axis.
